(19) United States
(12) Patent Application Publication
(10) Pub. No.: US 2005/0011238 A1
(43) Pub. Date: Jan. 20, 2005

(54) Electronic locking system

(76) Inventor: Benoit Roberge, Saint-Basile-le-Grand (CA)

Correspondence Address: ST. ONGE STEWARD JOHNSTON & REENS, LLC, 986 BEDFORD STREET, STAMFORD, CT, 06905-5619, US

(21) Appl. No.: 10/861,071

(22) Filed: Jun. 4, 2004

(30) Foreign Application Priority Data
Jun. 6, 2003 (CA) 2,430,542

(51) Int. Cl. B60R 25/00

(52) U.S. Cl. 70/256; 70/277

(57) ABSTRACT

An electronic locking system for locking a door of a chamber. The system comprises a housing, securing means for securing the housing inside the chamber in a manner that said electronic locking system is not visible from outside of the chamber, a lock member mounted within the housing, controllable moving means mounted within the housing for moving the lock member between a lock position wherein the door is locked and an unlock position wherein the door is unlocked, a radio receiver operatively connected to the controllable moving means to control the controllable moving means by producing a control signal; and a remote control having a user interface for wireless control of the controllable moving means via the radio receiver.

This application claims priority of pending Canadian Patent Application No. 2,430,542 filed Jun. 6, 2003.

### FIELD OF THE INVENTION

The present invention relates generally to an electronic locking system for locking the door of a chamber, such as the door of a trailer.

### BACKGROUND OF THE INVENTION

Locking systems are widely available. They are primary used to safeguard precious goods from being accessible from unauthorized access. More than often, these systems require the use of a physical key or key card, as on a door, to secure it. Other systems require the use of a padlock for example.

One drawback of these locking systems is that an unauthorized person has an easy access to the locking system and therefore could break through the locking system in order to gain access. For example, some of the padlocks available can be easily cut.

Another drawback of such systems is that they are not very efficient to protect containers commonly used by construction workers or persons using such containers. These containers are often installed in pick-up trucks for facilitating transportation of tools. Such containers often carry a content having great value and are simply locked by padlocks installed outside the containers.

Therefore, there is thus indeed a need for a locking system that is more secure than locking systems of the prior art and that does not require the use of a physical key to activate or deactivate the locking system.

### SUMMARY OF THE INVENTION

An object of the present invention is to provide an electronic locking system that is more secure than locking systems of the prior art.

Another object of the present invention is to provide an electronic locking system that does not require the use of a physical key to activate or deactivate the locking system.

According to the present invention, there is provided an electronic locking system for locking a door of a chamber. The system comprises a housing, securing means for securing the housing inside the chamber in a manner that said electronic locking system is not visible from outside of the chamber, a lock member mounted within the housing, controllable moving means mounted within the housing for moving the lock member between a lock position where the door is locked and an unlock position where the door is unlocked, a radio receiver operatively connected to the controllable moving means to control the controllable moving means by producing a control signal, and a remote control having a user interface for wireless control of the controllable moving means via the radio receiver.

Preferably, the controllable moving means comprises an actuator mounted within the housing and being responsive to the control signal of the radio receiver, the actuator having an end coupled to the lock member, the end of the actuator being movable between a first position causing the lock member to be in said lock position and a second position causing the lock member to be in said unlock position.

Preferably, the controllable moving means comprises a rotating element, a first rod member having a first end mounted on the rotating element for rotating the first rod, and a second end. The controllable moving means also comprises a second rod member having a first end pivotably mounted to the end of the actuator and a second end pivotably mounted to the first rod member, between the first and second ends of the first rod member, to rotate the first rod about the rotating element, and a third rod member having a first end pivotably mounted to the second end of the first rod member and a second end mounted to the locking member to move the lock member between said lock and unlock positions upon rotation of the first rod.

According to the present invention, there is also provided an electronic locking system for locking a door of a chamber. The electronic locking system comprises a housing, securing means for securing the housing inside the chamber in a manner that said electronic locking system is not visible from outside of the chamber, a lock member mounted within the housing, and controllable moving means mounted within the housing for moving the lock member between a lock position where the door is locked and an unlock position where the door is unlocked. The controllable moving means comprises an actuator mounted within the housing, the actuator having an end coupled to the lock member. The end of the actuator is movable between a first position causing the lock member to be in said lock position and a second position causing the lock member to be in said unlock position. The electronic locking system also comprises a radio receiver operatively connected to the controllable moving means to control the controllable moving means by producing a control signal, and a remote control having a user interface for wireless control of the controllable moving means via the radio receiver.

According to the present invention, there is also provided an electronic locking system for locking a door of a chamber. The electronic locking system comprises a housing, securing means for securing the housing inside the chamber in a manner that said electronic locking system is not visible from outside of the chamber, a lock member mounted within the housing, and controllable moving means mounted within the housing for moving the lock member between a lock position where the door is locked and an unlock position where the door is unlocked. The controllable moving means comprises an actuator mounted within the housing, the actuator having an end coupled to the lock member. The end of the actuator is movable between a first position causing the lock member to be in said lock position and a second position causing the lock member to be in said unlock position. The controllable moving means also comprises a rotating element, a first rod member having a first end mounted on the rotating element for rotating the first rod, and a second end, a second rod member having a first end pivotably mounted to the end of the actuator and a second end pivotably mounted to the first rod member, between the first and second ends of the first rod member, to rotate the first rod about the rotating element, and a third rod member having a first end pivotably mounted to the second end of the first rod member and a second end mounted to the locking member to move the lock member between said lock and unlock positions upon rotation of the first rod. The electronic locking system also comprises a radio receiver operatively connected to the controllable moving means to control the controllable moving means by producing a control signal, and a remote control having a user interface for wireless control of the controllable moving means via the radio receiver.

### BRIEF DESCRIPTION OF THE DRAWINGS

A detailed description of preferred embodiments will be given herein below with reference to the following drawings, in which like numbers refer to like elements:

FIG. 1 is a schematic top view of an electronic locking system according to a preferred embodiment of the present invention.

FIG. 2 is a schematic perspective view of the electronic locking system shown in FIG. 1 with a removable lid, according to a preferred embodiment of the present invention.

FIG. 3 is a schematic back view of two electronic locking system mounted on a door inside a chamber according to a preferred embodiment of the present invention.

FIG. 4 is a schematic front view of the door shown in FIG. 3 viewed from outside the chamber.

### DETAILED DESCRIPTION OF THE PREFERRED EMBODIMENTS

Referring now to FIGS. 1 to 4, there is shown an electronic locking system 8 for locking a door 6 of a chamber according to the present invention. The electronic locking system 8 comprises a housing 2 and a securing device 4 for securing the housing 2 inside the chamber in a manner that the electronic locking system 8 is not visible from outside of the chamber. Preferably, the securing device 4 comprises holes 20 for facilitating fixation of the housing 2 inside the chamber to allow a nuts-and-bolts 22 configuration. The nuts, as well as the bolts, could be provided with the locking system 8 but could also be, for example, the nuts-and-bolts 22 already mounted on the door 6 of a trailer to secure a mobile rod 24, as illustrated in FIG. 4. In that case, the housing 2 is mounted on the other side of the door 6, i.e. within the chamber, using the nuts-and-bolts 22.

The electronic locking system 8 also comprises a lock member 10 mounted within the housing 2 and a controllable moving device 12 mounted within the housing 2 for moving the lock member 10 between a lock position where the door is locked, and an unlock position where the door is unlocked. Preferably, in the lock position, the lock member ID extends outside of the housing 2, and, in the unlock position the lock member 10 extends within the housing 2. The electronic locking system 8 also comprises a radio receiver 14 operatively connected to the controllable moving device 12 to control the controllable moving device 12 by producing a control signal, and a remote 16 control having a user interface 18 for wireless control of the controllable moving device 12 via the radio receiver 14.

Preferably, the controllable moving device 12 comprises an actuator 26 mounted within the housing 2 and being responsive to the control signal of the radio receiver 14. The actuator 26 has an end 50 coupled to the lock member 10. The end 50 of the actuator 26 is movable between a first position causing the lock member 10 to be in the lock position and a second position causing the lock member 10 to be in the unlock position.

Preferably, the controllable moving device 12 comprises a rotating element 28, a first rod 30 member having a first end mounted on the rotating element 28 for rotating the first rod 30, and a second end. The controllable moving device 12 also comprises a second rod 32 member having a first end pivotably mounted to the end 50 of the actuator 26 and a second end pivotably mounted to the first rod 30 member, between the first and second ends of the first rod 30 member, to rotate the first rod 30 about the rotating element 28, and a third rod 34 member having a first end pivotably mounted to the second end of the first rod 30 member and a second end mounted to the locking member to move the lock member 10 between said lock and unlock positions upon rotation of the first rod 30.

Preferably, the electronic locking system 8 comprises a restraining device for restraining the rotation of the rotating element 28 that could be caused, for example, by vibrations during transportation of the chamber. The restraining device could be a spring element 36 having an end resting against one side of the rotating element 28.

Preferably, the rotating element 28 has a hexagonal shape or any another shape so that the spring element 36 exerts a pressure on a side of the rotating element 28. The pressure exerted by the spring element 36 on the rotating element 28 prevents an unwanted rotation of the rotating element 28.

Preferably, a hollow guide member 38 is mounted within the housing 2 for guiding the lock member 10 between the lock and unlock positions.

Preferably, a battery 46 could be used to power the radio receiver 14. Alternatively, the radio receiver 14 could be powered by the vehicle main battery 46 if the locking system 8 is mounted in a car or in a trailer for example. Preferably, the battery 46 is a twelve (12) volts DC battery 46.

A battery 46 charger could also be connected to the battery 46 to recharge it when needed.

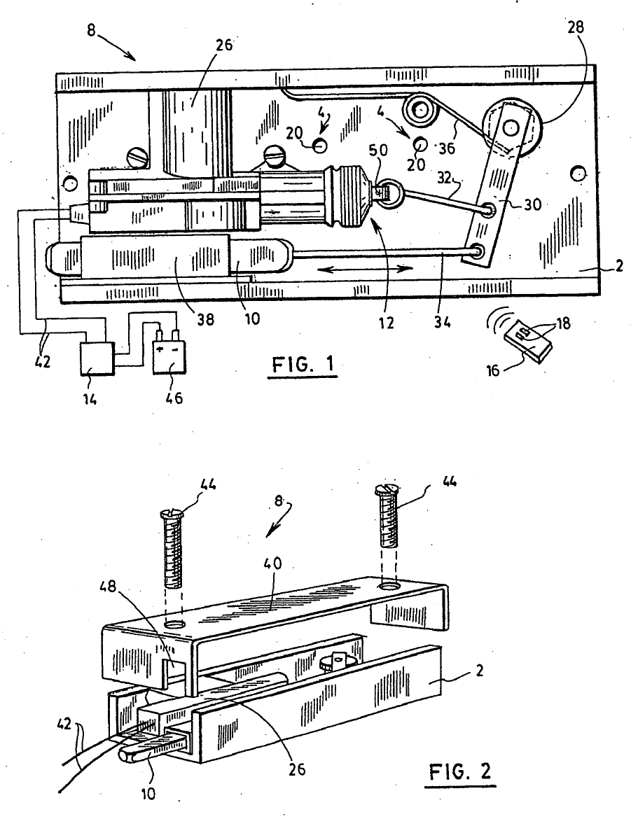

Referring now to FIG. 2, a removable lid 40 is preferably covering the housing 2. The lid 40 has an opening 48 at one end to allow passage of the lock member 10 outside the housing 2. Wires 42 of the actuator 26 can pass through this opening 48 or through another opening provided to that purpose. Preferably, the lid 40 is secured to the housing 2 by screws 44.

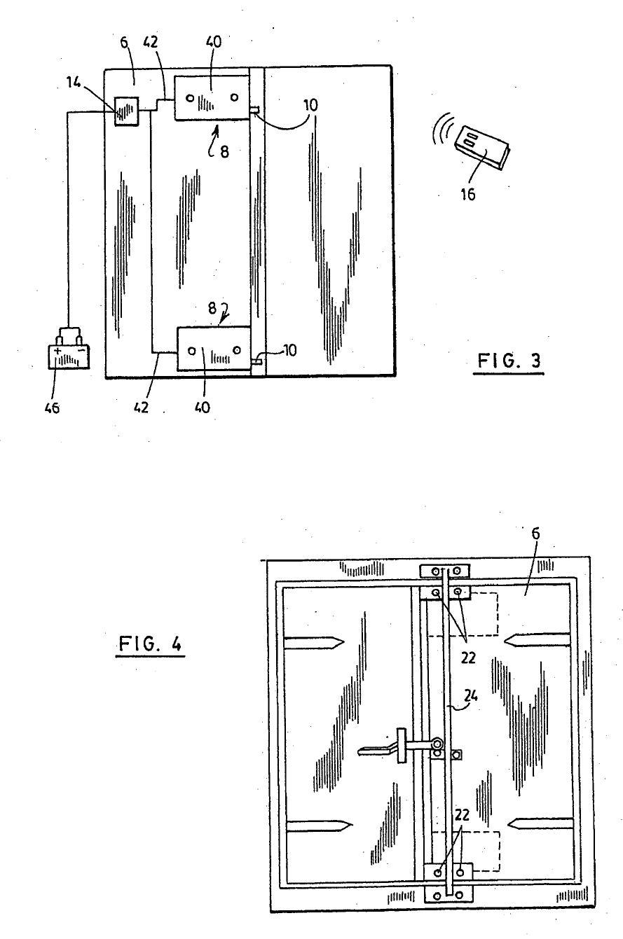

Now turning to FIG. 3, one or more locking systems 8 can be used conjointly. For example, one locking system 8 could be used at the top and bottom ends of the door 6. If such a configuration is used, the radio receiver 14 is connected to both locking systems 8 in order for them to operate in synchronization, so that the lock member 10 of each of the locking systems 8 operates in the same position.

To operate the locking system 8, the remote control 16 has to be used. For example, by pushing a button on the user interface 18 on the remote control 16, the remote control 16 sends a signal to the radio receiver 14. The radio receiver 14 receives the control signal and produces a control signal to control the actuator 26.

The control signal is current pulses that make the actuator 26 work. The current pulses are supplied from the battery 46, under the control of the radio receiver 14. Depending on the signal received from the remote control 16, the radio receiver 14 generates a different current pulse which drives the end 50 of the actuator 16, thus causing the lock member 10 to move between the lock and unlock positions.

As shown in FIG. 4, when the door 6 of the chamber is closed, the locking system is not visible from outside the chamber, thus minimizing the risks from being tampered with. To lock or unlock the door 6, the remote control 16 has to be used. The position of the lock member 10 is controlled from outside the chamber and there is no access to the locking system 8 from outside the chamber once the door 6 is locked.

This locking system 8 could be used for various types of doors, such as guillotine doors, patio doors, caravan doors, mobile house doors, garage doors, etc . . .

While embodiments of this invention have been described above and illustrated in the accompanying drawings, it will be evident to those skilled in the art that changes and modifications may be made therein without departing from the essence of this invention.

1. An electronic locking system for locking a door of a chamber, the system comprising:
a housing;
securing means for securing the housing inside the chamber in a manner that said electronic locking system is not visible from outside of the chamber;
a lock member mounted within the housing;
controllable moving means mounted within the housing for moving the lock member between a lock position where the door is locked and an unlock position where the door is unlocked;
a radio receiver operatively connected to the controllable moving means to control the controllable moving means by producing a control signal; and
a remote control having a user interface for wireless control of the controllable moving means via the radio receiver.

2. The electronic locking system according to claim 1, wherein the controllable moving means comprises an actuator mounted within the housing and being responsive to the control signal of the radio receiver, the actuator having an end coupled to the lock member, the end of the actuator being movable between a first position causing the lock member to be in said lock position and a second position causing the lock member to be in said unlock position.

3. The electronic locking system according to claim 2, wherein the controllable moving means comprises:
a rotating element;
a first rod member having a first end mounted on the rotating element for rotating said first rod, and a second end;
a second rod member having a first end pivotably mounted to the end of the actuator and a second end pivotably mounted to the first rod member, between the first and second ends of the first rod member, to rotate said first rod about the rotating element; and
a third rod member having a first end pivotably mounted to the second end of the first rod member and a second end mounted to the locking member to move the lock member between said lock and unlock positions upon rotation of the first rod.

4. The electronic locking system according to claim 3, comprising restraining means for restraining rotation of the rotating element.

5. The electronic locking system according to claim 4, wherein the rotating element has a hexagonal shape.

6. The electronic locking system according to claim 5, comprising a spring element to restraint the rotation of the rotating element from pivoting on itself, the spring element having an end resting against one side of the rotating element.

7. The electronic locking system according to claim 1, comprising a hollow guide member mounted within the housing for guiding the lock member between the lock and unlock positions.

8. The electronic locking system according to claim 1, wherein the securing means comprises holes for facilitating fixation of the housing inside the chamber.

9. The electronic locking system according to claim 1, wherein the housing comprises a removable lid.

10. The electronic locking system according to claim 1, comprising a plurality of said housing, said securing means, said lock member, and said controllable moving means, said radio receiver controlling the plurality of said controllable moving means.

11. The electronic locking system according to claim 1, wherein, in the lock position, the lock member extends outside of the housing, and, in the unlock position, the lock member extends within the housing.

12. The electronic locking system according to claim 2, comprising a hollow guide member mounted within the housing for guiding the lock member between the lock and unlock positions.

13. The electronic locking system according to claim 3, comprising a hollow guide member mounted within the housing for guiding the lock member between the lock and unlock positions.

14. The electronic locking system according to claim 2, wherein the securing means comprises holes for facilitating fixation of the housing inside the chamber.

15. The electronic locking system according to claim 2, wherein the housing comprises a removable lid.

16. The electronic locking system according to claim 6, wherein the housing comprises a removable lid.

17. The electronic locking system according to claim 3, comprising a plurality of said housing, said securing means, said lock member, and said controllable moving means, said radio receiver controlling the plurality of said controllable moving means.

18. An electronic locking system for locking a door of a chamber, the system comprising:
a housing;
securing means for securing the housing inside the chamber in a manner that said electronic locking system is not visible from outside of the chamber;
a lock member mounted within the housing;
controllable moving means mounted within the housing for moving the lock member between a lock position where the door is locked and an unlock position where the door is unlocked, the controllable moving means comprising an actuator mounted within the housing, the actuator having an end coupled to the lock member, the end of the actuator being movable between a first position causing the lock member to be in said lock position and a second position causing the lock member to be in said unlock position;
a radio receiver operatively connected to the controllable moving means to control the controllable moving means by producing a control signal; and
a remote control having a user interface for wireless control of the controllable moving means via the radio receiver.

19. An electronic locking system for locking a door of a chamber, the system comprising:
a housing;
securing means for securing the housing inside the chamber in a manner that said electronic locking system is not visible from outside of the chamber;
a lock member mounted within the housing;
controllable moving means mounted within the housing for moving the lock member between a lock position where the door is locked and an unlock position where the door is unlocked, the controllable moving means comprising:
an actuator mounted within the housing, the actuator having an end coupled to the lock member, the end of the actuator being movable between a first position causing the lock member to be in said lock position and a second position causing the lock member to be in said unlock position;
a rotating element;
a first rod member having a first end mounted on the rotating element for rotating said first rod, and a second end;
a second rod member having a first end pivotably mounted to the end of the actuator and a second end pivotably mounted to the first rod member, between the first and second ends of the first rod member, to rotate said first rod about the rotating element; and
a third rod member having a first end pivotably mounted to the second end of the first rod member and a second end mounted to the locking member to move the lock member between said lock and unlock positions upon rotation of the first rod;
a radio receiver operatively connected to the controllable moving means to control the controllable moving means by producing a control signal; and
a remote control having a user interface for wireless control of the controllable moving means via the radio receiver.
